(19) United States
(12) Patent Application Publication
(10) Pub. No.: US 2003/0157394 A1
(43) Pub. Date: Aug. 21, 2003

(54) Energy converting polar plate device and method for the preparation thereof

(76) Inventor: Yuji Kohara, Hiroshima (JP)

Correspondence Address: BIRCH STEWART KOLASCH & BIRCH, PO BOX 747, FALLS CHURCH, VA, 22040-0747, US

(21) Appl. No.: 10/077,990

(22) Filed: Feb. 20, 2002

(51) Int. Cl. H01M 4/96

(52) U.S. Cl. 429/42; 429/44

(57) ABSTRACT

An energy converting polar plate device including at least one energy converting polar plate containing graphite, melamine resin, carbon, carbonized calcium and method for the preparation thereof for generating effective electric power energy from the hydrocarbon thereof.

### BACKGROUND OF THE INVENTION

1. Field of the Invention

The present invention relates to an energy converting polar plate device and method for the preparation thereof, and more particularly, to an improved energy converting polar plate device for effectively generating electric energy from hydrocarbon thereof so as to use in various energy fields of the internal and external combustion engines, and method for the preparation thereof.

2. Description of Related Art

Various types of energy converting polar plate devices and methods for the preparation thereof are known in the art. Recently, many people have tried to get effective electric power generation in a lot of studies. However, it is hard to get the effective electric power generation of hydrogen and electric energy from hydrocarbon since several factors have involved complicatedly and acted mutually to each other. Therefore, up to date, it is not disclosed rapid progress on the transformation from hydrocarbon to electric energy and hydrogen.

Also, today energy of power generation is obtained by thermal, wind power, hydroelectric, nuclear power and so on. Especially nuclear power generation is obtainable big heat capacity by small quantity of fuel. However, existing systems of power generation are not able to avoid problems of high cost of maintenance and secondary disaster. And, natural resources, which are limited and for that they cannot be eternal energy, are essential in thermal and nuclear power generation.

### SUMMARY OF THE INVENTION

Accordingly, it is an object of the present invention to provide an improved energy converting polar plate device and method for the preparation thereof which eliminates the above problems encountered with conventional energy converting polar plates and method for the preparation thereof.

Another object of the present invention is to provide an energy converting polar plate device which includes graphite and suitable quantity of melamine resin for effectively generating electric energy and hydrogen from hydrocarbon thereof.

A further object of the present invention is to provide an improved method for the preparation of an energy converting polar plate device which comprises the steps of mixing scale like graphite and suitable quantity of melamine resin, making a compound of melting smashed carbon and carbonized calcium mixed francium or melamine resin, and using the products from the above steps as a binder, mixing smashed carbon, graphite, carbonized calcium, and pressing the mold material in various types.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a perspective view of an energy converting polar plate device according to the present invention;

FIG. 2 is a perspective view of an energy converting polar plate device assembly according to the present invention; and

FIGS. 3(A) and 3(B) are manufacturing steps of the energy polar plate device according to the present invention.

### DETAILED DESCRIPTION OF THE PREFERRED EMBODIMENTS

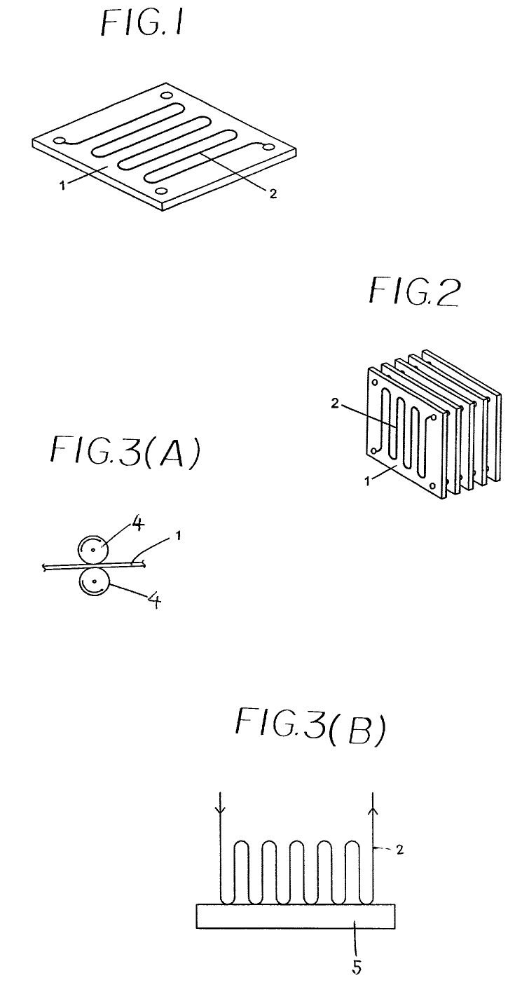

Referring now in detail to the drawings for the purpose of illustrating preferred embodiments of the present invention, the energy converting polar plate device as shown in FIGS. 1 and 2, includes a polar plate 1 and a polar wire 2 disposed on the polar plate 1 for generating effective electric power energy and hydrogen from hydrocarbon of the polar plate 1 for using in various fields.

The polar plate 1 contains a list of carbonized silicon for making a good conductor on level of the molecule of carbon.

The polar plate 1 contains scale like graphite and a suitable quantity of melamine in BOKUJYU, an ink stick gel.

The polar plate 1 contains smashed carbon and carbonized calcium mixed with melamine resin.

The polar plate 1 contains scale like graphite, smashed carbon, carbonized calcium and melamine resin as a binder, and smashed carbon, scale like graphite, graphite and carbonized carbon as a basic material.

Referring to FIGS. 3(A) and 3(B), the method for the preparation of an energy converting polar plate device according to the present invention comprises the steps of: (a) mixing scale like graphite and a suitable quantity of melamine resin in BOKUJYU, and ink stick gel; (b) making a compound produced by melting smashed carbon and carbonized calcium mixed with melamine resin; (c) providing the product produced by the step (a) as a binder and the product produced by the step (b) as a basic material, and molding the binder and the basic material by using a hydrostatic press, a hammer press and a roll press of rollers 4 as shown in FIG. 3(A); and (d) casting by heating the product from the step (c) and removing water from the product and getting a designed shape with correction of plant, hardness and homogenization of the buried part of the polar wire 2 on the polar plate 1. The method of the present invention comprises the steps of further cooling the product of the step (c) by using a coolant 5 as shown in FIG. 3(B) for improving actual electrical conductivity.

For example, in application of the energy converting polar plate device according to the present invention, it is explained in the case for fuel energy of an automobile. In the present invention, the automobiles get energy by burning gasoline or gas oil or LPG. And generally, its efficiency is about 10 Km/Litter. And after combustion of those fuel, environment pollution is getting more aggravated by byproducts such as NO_{X}, SO_{X}, CO₂ and so on. The product of the present invention is turned possible to take out hydrocarbon and hydrogen from gasoline effectively and to get effective convert of energy by burning those hydrocarbon and hydrogen. And, also it turned possible to convert into hydrogen and electric energy. It is possible to make recycle of energy, and to reduce byproducts such as NO_{X}, SO_{X}, CO₂ and so on, in addition to those, it is possible to make it harmless.

Accordingly, the present invention is able to make systems smaller and lighter and materializes easy maintenance. Also, due to convert of energy from hydrocarbon, it makes free from secondary disaster and public pollution. Therefore, the present invention can realize higher efficient and safer type of the power generator for coming generation in the various fields. Further, such power generator is completely different from the existing types of power generators in its principle and method. Therefore, it may be initial explosive of a big revolution of a electric power generation.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An energy converting polar plate device comprising:
at least one energy converting polar plate, said energy converting polar plate containing graphite, melamine resin, carbon, and carbonized calcium for generating effective electric power energy from hydrocarbon thereof.

2. The energy converting polar plate device of claim 1, wherein said energy converting polar plate further contains a small amount of carbonized silicon for using a good conductor on the level of the molecule of carbon.

3. The energy converting polar plate device of claim 1, wherein said graphite is a scale like configurated form and said melamine resin is an ink stick gel.

4. A method for the preparation of an energy converting polar plate device comprising the steps of:
(a) mixing scale like graphite and a suitable quantity of melamine resin in an ink stick gel;
(b) making a compound produced by melting smashed carbon and carbonized calcium mixed with melamine resin;
(c) providing the product produced by said step (a) as a binder and the product produced by said step (b) as a basic material, and molding the products of the binder and the basic material by a pressing process; and
(d) casting by heating the molded product of said step (c) and removing water therefrom for forming various types of forms.

5. The method for the preparation of an energy converting polar step (d) includes getting a designed shape with correction of plant, hardness and homogenization of the buried part of a polar wire disposed on a polar plate.

6. The method for the preparation of an energy converting polar plate device of claim 4, further comprising the steps of using a coolant for improving actual electric conductivity.

7. The method for the preparation of an energy converting polar plate device of claim 4, wherein said pressing process is a press selected from group consisting a hydrostatic press, hammer press, and a roll press.
